(19) United States
(12) Patent Application Publication
(10) Pub. No.: US 2011/0189589 A1
(43) Pub. Date: Aug. 4, 2011

(54) COMPOSITE POROUS CATALYSTS

(75) Inventors: Jonah Daedalus Erlebacher, Chevy Chase, MD (US); Joshua Synder, Baltimore, MD (US)

(73) Assignee: The Johns Hopkins University, Baltimore, MD (US)

(21) Appl. No.: 13/016,692

(22) Filed: Jan. 28, 2011

Related U.S. Application Data
(60) Provisional application No. 61/299,672, filed on Jan. 29, 2010.

(51) Int. Cl. H01M 4/92; B01J 35/10; B01J 23/42; B01J 23/89; B01J 21/06; B01J 23/745; B01J 23/75; B01J 23/755; B01J 23/72; B01J 23/46; B01J 21/02; B01J 23/34; B01J 23/44; B01J 23/36; B01J 23/22; B01J 23/26; B01J 25/00; B01J 37/02; B01J 31/02; H01M 4/88

(52) U.S. Cl. 429/523; 502/300; 502/339; 502/326; 502/350; 502/338; 502/325; 502/337; 502/345; 502/355; 502/324; 502/353; 502/319; 502/301; 502/167; 429/532; 429/524; 429/527

(57) ABSTRACT

A composite catalyst for a chemical reaction includes a porous metal catalyst that catalyzes a plurality of reactants to provide a reaction product, and a reaction-enhancing material disposed within pores defined by the porous metal catalyst. The reaction-enhancing material enhances attraction of at least one reactant of the plurality of reactants into the pores defined by the porous metal catalyst and enhances expulsion of the reaction product from the pores defined by the porous metal catalyst. A fuel cell according to an embodiment of the current invention has a first electrode, a second electrode spaced apart from the first electrode, and an electrolyte arranged between the first and the second electrodes. The at least one of the first and second electrodes is at least one of coated with or comprises a composite catalyst. A method of producing a composite catalyst includes providing a metal alloy, de-alloying the metal alloy to provide a porous metal catalyst that catalyzes a plurality of reactants to provide a reaction product, and adding a reaction-enhancing material to the porous metal catalyst such that the reaction-enhancing material is disposed within pores defined by the porous metal catalyst.

### CROSS-REFERENCE TO RELATED APPLICATIONS

This application claims priority to U.S. Provisional Application No. 61/299,672 filed Jan. 29, 2010, the entire content of which is hereby incorporated by reference.

This invention was made using U.S. Government support under U.S. Department of Energy, Basic Energy Sciences Grant No. DE-FG02-05ER15727. The U.S. Government has certain rights in this invention.

### BACKGROUND

1. Field of Invention

The current invention relates to composite catalysts, and more particularly to composite catalysts that include a porous metal catalyst and a reaction-enhancing material disposed in pores of the porous metal catalyst.

2. Discussion of Related Art

High specific surface area metals (specific area >5 m²/g) are widely used in many catalytic reaction industries, such as in the chemical synthesis industry (e.g., Raney catalysts) and in many energy generation technologies (e.g., fuel cells). The traditional method to make high surface area metal catalysts has been to make large quantities of small particles, sometimes called nanoparticles when their diameter is of order nanometers up to hundreds of nanometers. More recently, high surface area nanoporous metals made by dealloying have been increasingly examined for catalysis. Reasons for this interest include their easy and environmentally friendly synthesis, good control over bulk composition and surface composition (so-called “core-shell” catalysts can be made), and the ability to make electrical contact to all surfaces.

The last characteristic is particularly important in electrocatalytic applications, and especially in energy applications. In fuel cells, catalytic electrodes are made by creating a composite catalyst comprised of metal nanoparticles (e.g., Pt) that are adsorbed onto larger carbon particles, all of which is bound together in a “paint” employing a polymeric binder (Nafion). There are many limitations inherent in this type of electrode architecture and there are multiple areas where improvement can be made. First, many of the particles may not be in good electrical contact with the external circuit. Second, reactants have to diffuse through the polymeric binder, and this can add extra diffusional resistance or block catalyst surfaces rendering them inactive.

In regard to fuel cell applications, note that all low-temperature proton exchange membrane fuel cells (PEMFCs), such as are envisioned for automotive applications to replace the internal combustion engines, require two catalytic electrodes: one to extract protons and electrons from fuels such as hydrogen or methanol, and one to re-combine these protons and electrons with oxygen to form water. Regardless of the fuel used in low-temperature polymer electrolyte membrane fuel cells (PEMFCs), be it hydrogen (J. Erlebacher, Solid State Physics 61, 77 (2009)), methanol (H. Liu, et al., J. Power Sources 155, 95 (2006)), or ethanol (A. Kowal, et al., Nature Materials 8, 325 (2009)), the primary catalytic bottleneck to the use of these devices are the slow kinetics of the cathodic oxygen reduction reaction (ORR) in which an oxygen molecule is reduced to water via a complex reaction pathway involving four electrons and four protons. Sluggish ORR kinetics accounts for approximately 80% of the losses in PEMFCs (T. Toda, H. Igarashi, H. Uchida, M. Watanabe, J. Electrochem. Soc. 146, 3750 (1999)). The most widely used and studied catalyst for the ORR has been Pt, but even on this single-component material the detailed reaction mechanism remains controversial as oxygen reduction on Pt is sensitive to many factors including catalyst crystal surface orientation (N. Markovic, H. Gasteiger, P. Ross, J. Phys. Chem. 99, 3411(1995); C. Zinola, A. Luna, W. Triaca, A. Arvia, Electrochim. Acta 39, 1627 (1994)), whether the catalyst form factor is nanoparticulate or bulk metal (E. Higuchi, H. Uchida, M. Watanabe, J. Electroanal. Chem. 583, 69 (2006)), and the electrolyte anion species (J. Wang, N. Markovic, R. Adzic, J. Phys. Chem. B 108, 4127 (2004)). There are two approaches being pursued to enhance the ORR for fuel cells: (1) the development of catalysts that exhibit only moderate activity when compared to Pt, yet are inexpensive and can be produced in significant quantities (M. Lefevre, E. Proietti, F. Jaouen, J. Dodelet, Science 324, 71(2009)), and (2) developing more Pt-based nanostructured alloy catalysts that, while still perhaps expensive, potentially yield orders of magnitude higher activities than Pt alone via a variety of mechanisms such as changes in the electronic structure, e.g., shifts in the d-band center, leading to more favorable interactions with reactants and products (V. Stamenkovic, et al., Science 315, 493 (2007); R. R. Adzic, et al. Top. Catal. 46, 249 (2007); B. Hammer, J. K. Norskov, Adv. in Catalysis 45, 71(2000)). There thus remains a need for improved catalysts and improved devices, such as fuel cells, that utilize the improved catalysts.

### SUMMARY

A composite catalyst for a chemical reaction according to an embodiment of the current invention includes a porous metal catalyst that catalyzes a plurality of reactants to provide a reaction product, and a reaction-enhancing material disposed within pores defined by the porous metal catalyst. The reaction-enhancing material enhances attraction of at least one reactant of the plurality of reactants into the pores defined by the porous metal catalyst and enhances expulsion of the reaction product from the pores defined by the porous metal catalyst.

A fuel cell according to an embodiment of the current invention has a first electrode, a second electrode spaced apart from the first electrode, and an electrolyte arranged between the first and the second electrodes. The at least one of the first and second electrodes is at least one of coated with or comprises a composite catalyst. The composite catalyst includes a porous metal catalyst that catalyzes a plurality of reactants to provide a reaction product, and a reaction-enhancing material disposed within pores defined by the porous metal catalyst. The reaction-enhancing material enhances attraction of at least one reactant of the plurality of reactants into the pores defined by the porous metal catalyst and enhances expulsion of the reaction product from the pores defined by the porous metal catalyst.

A method of producing a composite catalyst according to an embodiment of the current invention includes providing a metal alloy, de-alloying the metal alloy to provide a porous metal catalyst that catalyzes a plurality of reactants to provide a reaction product, and adding a reaction-enhancing material to the porous metal catalyst such that the reaction-enhancing material is disposed within pores defined by the porous metal catalyst. The reaction-enhancing material enhances attraction of at least one reactant of the plurality of reactants into the pores defined by the porous metal catalyst and enhances expulsion of the reaction product from the pores defined by the porous metal catalyst.

### BRIEF DESCRIPTION OF THE DRAWINGS

FIG. 1 is a schematic illustration of a composite catalyst according to an embodiment of the current invention. In this example, an ionic-liquid (light shading) impregnates nanoporous metal particle shown in cross-section. The pore diameter may range from an average of 2 nm upward. For the example of oxygen reduction, the metal is nanoporous nickel-platinum, and the ionic liquid has the bulleted characteristics. Examples of some suitable ionic liquids for particular applications are discussed in the text.

FIG. 2 shows a characterization the ORR of different catalysts using a rotating disk electrode in 0.1M HClO₄ at a rotation rate of 1600 rpm and a temperature of 25° C. The sample had roughness factor of R=143, corresponding to a dealloying depth of ˜300 nm and a hydrogen UPD surface area of 28 cm².

FIG. 3 provides half-wave position data of the np-NiPt and np-NiPt+MTBD-beti composite catalysts according to an embodiment of the current invention for oxygen reduction at various dealloyed depths or roughness factors.

FIG. 4 shows a schematic illustration of a proton exchange membrane fuel cell.

FIG. 5A shows a TEM of a wedge slice of a NiPt foil dealloyed in 0.05 M NiSO₄ at 2.1 V vs. RHE after residual surface oxide has been reduced in 0.1 M H₂SO₄; inset is a lower magnification view showing a sharp interface between the porous dealloyed region (left) and undealloyed metal (right).

FIG. 5B shows high resolution TEM of dealloyed section with visible lattice fringes. The Fourier transform in the inset confirms that np-NiPt is composed of an extended crystalline network.

FIG. 6 shows cyclic voltammograms of Ni, Pt and np-NiPt in deoxygenated 0.1 M NaOH measured with a sweep rate of 50 mV/s. The solid black line corresponds to a np-NiPt electrode dealloyed for a very short period of time with a H_{UPD} surface area of 4.64 cm² and the dotted black line corresponds to a np-NiPt electrode dealloyed for a longer period of time with a H_{UPD} surface area of 28 cm². The current values for planar Ni and Pt foils are normalized by their geometric surface area and plotted with the y-axis on the left, while the two np-NiPt samples' current values are normalized by their respective H_{UPD} surface area of the electrodes and plotted with the y-axis on the right. Note that the ratio of the NiOH peak current associated with surface Ni near 0.8 V vs. RHE to the non-Faradaic capacitive charging current gives a measure of the residual surface Ni. That this ratio decreases significantly with deeper dealloying means there is little residual surface Ni in the final dealloyed layer.

FIG. 7 shows cyclic voltammograms of np-NiPt (blue) and np-NiPt+[MTBD][beti] (red) electrodes in 0.1 M H₂SO₄ at 25° C. and 50 mV/s. H_{UPD} surface areas were calculated by integrating the current under the H_{UPD} desorption wave (from ˜0 V to ˜0.4 V vs. RHE), subtracting out the contribution from double layer capacitance and assuming 210 μCcm⁻².

FIG. 8 shows the ionic structure of [MTBD][beti] IL where the perfluoroinated side chains of the [beti]⁻ anion make the IL hydrophobic and give the IL its relatively high O₂ solubility.

FIG. 9A shows an example of potentiostatic ORR measurements where the current is steady for nearly 300 seconds at 0.85 V vs. RHE at the above stated ORR conditions.

FIG. 9B shows potentiostatic ORR curves for np-NiPt in O₂ saturated 0.1 M HClO₄ at 25° C. (R=143) with RDE rotation rates of 400, 900, 1600 and 2500 rpm.

FIG. 10 provides results of a stability test of np-NiPt+[MTBD][beti] IL composite electrode by cycling the potential between 0.6 V and 0.96 V vs. RHE in O₂ saturated 0.1 M HClO4 while rotating at 1600 rpm for a duration of 3000 cycles. The gray curve represents the catalytic activity before the stability test while the black curve is the resulting activity after testing. While there is little to no loss in current within the kinetic region, indicative of the composite catalyst's stability, there is a slight drop in the diffusion limited current. We conjecture that this discrepancy is due to the effect that while cycling, residual Ni is removed from the structure and redeposited on its surface. Therefore, while measuring the ORR activity after cycling, the lower diffusion limited current is caused by corrosion of residual Ni on the surface.

FIG. 11 provides potentiostatic ORR curves for np-NiPt (blue), np-NiPt+[MTBD][beti] (red) and np-NiPt+[TBP][TMDP] (black) electrodes in O₂ saturated 0.1 M HClO₄ at 25° C. (R=143 for all electrodes) with a RDE rotation rate of 1600 rpm.

FIG. 12 provides Tafel plots of np-NiPt and np-NiPt+[MTBD][beti] showing a shift in jₖ for the composite catalyst due to an increased attempt frequency.

FIG. 13A provides a comparison of surface kinetic current density at 0.9 V vs. RHE in O₂ saturated 0.1 M HClO₄ of np-NiPt and np-NiPt+[MTBD][beti] compared to the low index crystalline facets of Pt₃Ni (Stamenkovic, V., Fowler, B., Mun, B., Wang, G., Ross, P., Lucas, C., Markovic N Improved Oxygen Reduction Activity on Pt₃Ni(111) via Increased Surface Site Availability. Science 315, 493-497 (2007)). The surface reactivity of np-NiPt alone may be an average associated with the nanoscopic facet orientations of the external pore surfaces, and the effect of the IL is to greatly magnify the reactivity.

FIG. 13B shows mass activity of np-NiPt and np-NiPt+[MTBD][beti] at 0.9 V vs. RHE as a function of dealloyed depth compared to commercial Pt/C catalyst on the left axis and specific activity by normalizing the kinetic current at 0.9 V vs. RHE for each dealloyed depth with the real H_{UPD} surface area again compared to commercial Pt/C catalyst on the right axis.

FIG. 14 shows kinetic current curves for np-NiPt electrodes dealloyed to various depths. Current converges at high overpotential and diverges at low overpotential with higher currents for electrodes with thicker dealloyed layer or higher loading.

FIG. 15 provides a schematic representation of the ORR on two different surfaces, smooth and porous, at both low and high overpotential. At high overpotential O₂ reduction probability is nearly unity, meaning that it reacts within the outermost surface giving an effective active surface area equal to the geometric surface area of the electrode. However, at lower overpotential, the O₂ molecules are more likely to rebound off of the smooth surface without reacting whereas with the porous electrode the O₂ molecule may become trapped, contacting the surface multiple times until it reduces and sampling more of the surface the further the over potential is lowered. This describes a scenario where in contrast to planar surfaces, for nanoporous electrodes A_{active} is itself a function of potential and is not always equal to the H_{UPD} surface area.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited herein are incorporated by reference as if each had been individually incorporated.

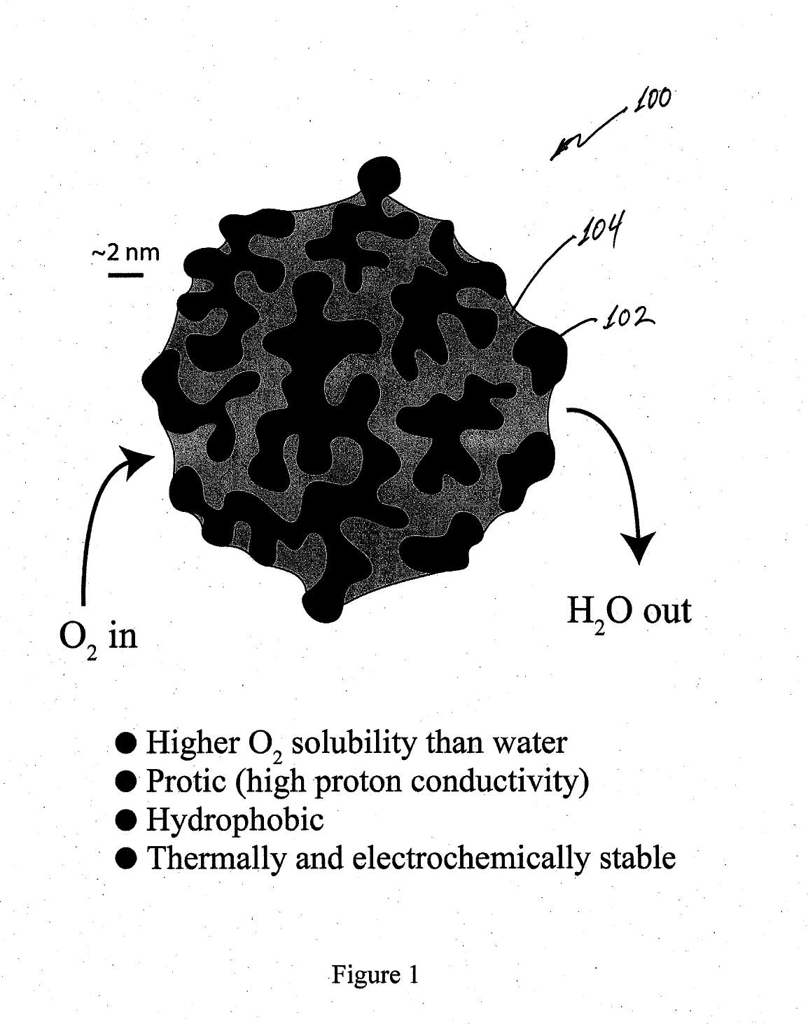

FIG. 1 is a schematic illustration of composite catalyst 100 according to an embodiment of the current invention. The composite catalyst 100 includes a porous metal catalyst 102 and a reaction-enhancing material 104 disposed within pores defined by the porous metal catalyst. The porous metal catalyst 102 catalyzes a plurality of reactants to provide a reaction product. There can be two, three or more reactants, depending on the particular application of an embodiment of the current invention. In addition, in some embodiments, there could be more than one reaction product. The reaction-enhancing material 104 enhances attraction of at least one reactant of the plurality of reactants into the pores defined by the porous metal catalyst 102. The reaction-enhancing material 104 thus helps to keep the reactants trapped in the pores of the porous metal catalyst until the reaction occurs. The reaction-enhancing material 104 also enhances expulsion of the reaction product from the pores defined by the porous metal catalyst.

In an embodiment of the current invention, the reaction-enhancing material 104 can be a liquid. However, the invention is not limited to only liquids for the reaction-enhancing material 104. It could more generally be a fluid, such as a liquid or a gas, or a material that changes phase between a solid and a liquid, for example, either before or after being disposed in the pores of the porous metal catalyst. The reaction-enhancing material 104 can also be a polymer, for example, according to other embodiments of the current invention. When the reaction-enhancing material 104 is a liquid, for example, then at least one reactant is more soluble in the reaction-enhancing material 104 than in a local environment that exposes the composite catalyst to the at least one reactant. The local environment could be, for example, a fluid that is in contact with the composite catalyst 100 and that contains both the reactants and reaction product. For example, the composite catalyst 100 could be exposed to the atmosphere to receive oxygen for an oxygen reduction reaction and the reaction product could be H₂O, for example in the form of water vapor or liquid water runoff. However, this is just one particular example for illustration purposes. The general concepts of the current invention are not limited to this particular example.

In an embodiment of the current invention, the reaction-enhancing material 104 can be a liquid in which the reaction product is less soluble than a local environment that receives the reaction product. According to an embodiment of the current invention, the porous metal catalyst 102 catalyzes an oxygen reduction reaction to provide H₂O as a reaction product, O₂ is more soluble in the reaction-enhancing material 104 than in the aqueous environment in which the composite catalyst sits, and the solubility of H₂O in the reaction-enhancing material 104 is lower than in the aqueous environment in which the composite catalyst sits. In this embodiment, the reaction-enhancing material is hydrophobic. The reaction-enhancing material 104 can be an ionic liquid for this embodiment of the current invention. For example, [7-methyl-1,5,7-triazabicyclo[4.4.0]dec-5-ene][bis(perfluoroethylsulfonyl)imide] ([MTBD][beti]) and/or [7-methyl-1,5,7-triazabicyclo[4.4.0]dec-5-ene][bis(trifluoromethylsulfonyl)imide] ([MTBD][Tf₂N]) have been found to be suitable materials for this embodiment of the current invention. However, the general concepts of the invention are not limited to only these reaction-enhancing materials for oxygen reduction reactions. Furthermore, the general concepts of the current invention are not limited to only oxygen reduction reactions.

The reaction-enhancing material 104 should also be selected from materials that do not interfere with the desired reaction, or at least interfere less than the amount of enhancement provided by the reaction-enhancing material 104. For many applications, it is also desirable for the composite catalyst, including the reaction-enhancing material 104, to be thermally stable over temperature ranges expected for the particular application, and electrochemically stable over the electrochemical potential range to which the catalyst will be exposed.

FIG. 1 illustrates the composite catalyst 100 in the form of a particle. In some embodiments, the composite catalyst 100 can be in the form of a powder, for example, that includes a plurality of particles. The particles can be produced to sizes desired for the particular application, such as particles on the order of tens of microns, for example, down to the order of nanometers. The composite catalyst 100 can also be in the form of other sub-millimeter or sub-micron structures other than particles, such as, but not limited to, wires with sub-millimeter or sub-micron widths, for example. In other embodiments, the composite catalyst 100 can be in the form of a bulk structure that is macroscopic in some dimension, such a sheet, granules, wires, etc. In other embodiments, the composite catalyst 100 can be in the form of a thin film, made, for instance, by sputtering or other forms of physical vapor deposition These are some examples of various structures that are possible for the composite catalyst 100 according to some embodiments of the current invention; however, the general concepts of the current invention are not limited to only these examples.

The porous metal catalyst 102 can include at least one of platinum, titanium, iron, cobalt, nickel, copper, iridium, rhenium, aluminum, manganese, palladium, osmium, rhodium, vanadium, chromium according to some embodiments of the current invention. The porous metal catalyst 102 can be, but is not limited to, porous metal catalysts as described in PCT/US2009/059544, filed Oct. 5, 2009, which claims priority to U.S. provisional application No. 61/181,795, filed May 28, 2009, which are by the same inventors and same assignee as the current application, the entire contents of both of which are incorporated herein by reference.

According to some embodiments of the current invention, the porous metal catalyst 102 can include platinum. The porous metal catalyst 102 can have a specific surface area that is greater than 5 m²/g and less than 100 m²/g according to some embodiments of the current invention. In some embodiments, the specific surface area is greater than 40 m²/g and less than 50 m²/g. In an embodiment of the current invention, the porous metal catalyst 102 has a specific surface area of about 44 m²/g. The specific surface area is a measure of the surface area divided by the mass of the material that is useful for providing a measure of the porosity for a fixed mass.

In some embodiments, the porous metal catalyst 102 is a porous metal alloy that further includes nickel. In further embodiments, the porous metal catalyst 102 is a porous metal alloy that consists essentially of platinum (Pt) and nickel (Ni). For example, the porous metal catalyst 102 can be a porous metal alloy further satisfying the following formula PtₓNi₁₋ₓ, where x is at least 0.6 and as large as 1. In the case in which x is equal to 1, all (or substantially all) Ni has been dealloyed leaving none behind in the resulting porous metal catalyst 102. In an embodiment of the current invention that has been found to be suitable for some applications, the porous metal catalyst 102 is about 67 at % platinum and 33 at % nickel (i.e., x is about 67). In this example, the porous metal catalyst 102 has a density of about 8 g/cm³. However, the invention is not limited to this particular embodiment. Furthermore, an increase or decrease of a couple of at % is also suitable for particular applications. In other embodiments, much less nickel remains, including an embodiment in which essentially no nickel remains in the porous metal catalyst 102.

The porous metal catalyst 102 can be a porous metal alloy that also includes at least one of titanium, iron, cobalt, nickel, copper, iridium, rhenium, aluminum, manganese, palladium, osmium, rhodium, vanadium, chromium in addition to platinum, for example.

The porous metal catalyst 102 according to some embodiments of the current invention has an ensemble average pore diameter that is less than about 10 μm. Although the pores may not be perfectly tubular, they can be characterized by an effective diameter. In some embodiments, the porous metal catalyst 102 has an ensemble average pore diameter that is less than 100 nm. In further embodiments, the porous metal catalyst 102 has an ensemble average pore diameter that is greater than 1 nm and less than 50 nm. In further embodiments, the porous metal catalyst 102 has an ensemble average pore diameter that is greater than 1 nm and less than 4 nm In still further embodiments, the porous metal catalyst 102 has an ensemble average pore diameter that is greater than 2 nm and less than 3 nm and an average ligament diameter that is greater than 2 nm and less than 3 nm. A porous metal of this kind has solid ligaments, and void in-between them. The ligament diameters and pore diameters are approximately the same, and the ranges of one are the ranges of the other.

The porous metal catalyst 102 according to some embodiments of the current invention can by itself provide a catalyst for oxygen reduction. An embodiment of the present invention includes a novel nanoporous metal (np-NiPt) formed by electrochemical dealloying of Ni-rich Ni/Pt alloys and impregnating it with a reaction-enhancing material 104. The composite catalyst according to this embodiment of the current invention magnifies the ORR activity of the base metal alloy by trapping the reactants within a highly porous matrix. The effect can lead to dramatic improvements in the electrochemical half-wave for the ORR, the open circuit potential, the current stability, and the performance in hydrogen fuel cells compared to conventional nanoparticle-based catalysts. The reaction-enhancing material 104 can provide further improvements by increasing the trapping of reactants and increasing the expulsion of reaction products to provide a more favorable environment for the reactions to occur.

The nanoporous Pt-based catalyst according to this embodiment of the current invention is formed by electrochemical dealloying of PtₓNi₁₋ₓ alloys (x<0.25). The PtₓNi₁₋ₓ alloys exhibit large, voltage-dependent magnification of the ORR activity compared to non-porous catalysts such as Pt nanoparticles, especially at low and moderate overpotentials. This material is easily processed into unsupported catalytic powders according to some embodiments and integrated into high-performance hydrogen/oxygen PEMFCs, for example.

Nanoporous Ni/Pt (np-NiPt) according to an embodiment of the current invention was fabricated by selective electrochemical dissolution (dealloying) of Ni from Ni-rich base alloys made by bulk solidification. From a thermodynamic standpoint, the Pt/Ni system is a good dealloying system because the components form a uniform solid solution with the face-centered cubic crystal structure across their entire composition range, and because Pt is much more noble than Ni; both of these characteristics together can lead to nanoporosity evolution during dissolution due to a kinetic instability that competes with dissolution of the less-noble alloy component with surface diffusion of the remaining component (J. Erlebacher, et al., Nature 410, 450 (2001)). In practice, however, the Ni/Pt system exhibits some complications. First, thermal processing of the base material often results either in segregation of Pt to the surface to form a passivating skin (T. Toda, H. Igarashi, H. Uchida, M. Watanabe, J. Electrochem. Soc. 146, 3750 (1999); V. Stamenkovic, et al., Science 315, 493 (2007)), or in Ni-rich alloys, the formation of a passivating nickel oxide (M. Pourbaix, Atlas of Electrochemical Equilibria in Aqueous Solutions (Pergamon Press, Oxford, New York, 1966)). These problems were overcome by dealloying in neutral electrolyte at high potentials, greater than 2.1V (all potentials here are reported versus the reversible hydrogen electrode, RHE). At these potentials, we suspect there is enough electrochemical driving force to break through any passivation layer. Once broken-through, exposed Ni is susceptible to dissolution. Chemical dissolution is assisted by acidification of the electrolyte in the vicinity of the etch front by hydrolysis of the surface Ni to a nickel hydroxide (Ni(OH)₂); Ni(OH)₂ is soluble in the acidified pores, but precipitates out of solution when it diffuses into the bulk of the neutral electrolyte. Copious amounts of Ni(OH)₂ are usually collected during the course of dealloying at the base of the electrolyte vessel. Dealloying in the Ni/Pt system can also be done in acidic solutions, but the neutral solutions are benign. More importantly, in neutral solutions, acidification of the electrolyte which generates the reduced species that participate in surface diffusion and porosity evolution is confined to the moving dissolution front (J. Snyder, K. Livi, J. Erlebacher, J. Electrochem. Soc. 155, C464 (2008)); behind the dissolution front, the material forms a surface oxide that morphologically stabilizes the nanoscale porosity. Dealloying was found to occur in alloys with Pt contents as low as 1% Pt, but good structurally stable porosity evolution were found to occur for compositions of Pt between 15-25%, of which the optimal ORR activity was centered at ˜23 at. % Pt.

Chemically, the composite catalyst 100 acts as a “sponge” or nanoreactor that soaks up reactants. Even for slow reactions, the reactivity in this system is greatly improved because the reactants are trapped within the catalyst until they finally react. We have implemented concepts of the composite catalyst to the particular problem of the oxygen reduction reaction (ORR), 2O₂+4H⁺+4e⁻→2H₂O. The ORR is the rate-limiting reaction in all hydrogen-oxygen fuel cells; it is the cathode reaction.

To make a composite ORR catalyst, we used a nanoporous Ni/Pt material (np-NiPt) that has been disclosed previously (PCT/US2009/059544 and U.S. Application No. 61/181,795, incorporated by reference herein). We impregnated the material with ionic liquids (IL) synthesized according to the method described in (Luo, et al., J. Phys. Chem. B, 113 (2009), 4181-4183.). Two ionic liquids (ILs) were chosen for this example: (1) [MTBD][beti], and (2) [MTBD][Tf2N]; the chemical formula of these compounds is given in the referenced paper. These ionic liquids have the characteristics that: (a) oxygen solubility is higher in these ILs than in water (this is related to the chemistry of the fluorinated side-chains), (b) they are “protic”, i.e., they have high proton conductivity, and (c) they are hydrophobic. The last characteristic means that the IL will expel the product water, and also means that if particles of np-NiPt impregnated with the IL are immersed in water or water vapor, the IL will not dissolve or otherwise leave the pores. Many other ionic liquids may be used for this application. Both of these ionic liquids performed nearly identically, so we will describe results for the np-NiPt+[MTBD] [beti] composite only.

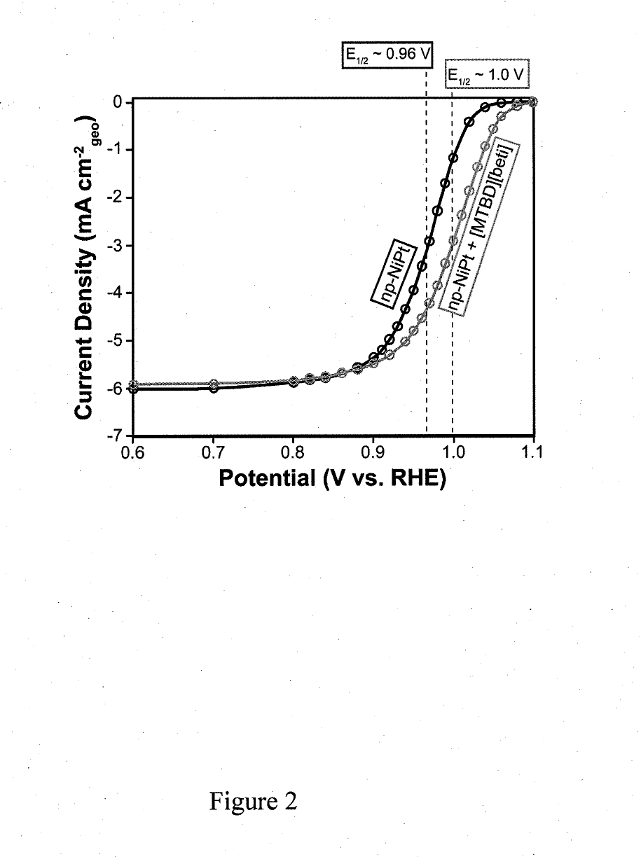

The performance of an oxygen reduction catalyst is characterized by an electrochemical test using a rotating disk electrode in an oxygen-saturated acid solution. FIG. 2 shows a comparison of two oxygen reduction catalysts. The axes are potential (vs. the reversible hydrogen electrode, RHE), and current density. Theoretically, a negative current corresponding to oxygen reduction should be measured at all potentials negative to 1.23 V, but in practice an “overpotential” must be applied to get the reaction going. So, for instance, looking at the industry standard of polycrystalline platinum (poly-Pt), one sees a turn-on of the ORR characterized by the half-wave position at ˜0.8 V. At much higher overpotential, the current levels off because the reaction becomes limited by diffusion of O₂ to the electrode from the electrolyte. In this graph, samples with platinum surface areas of 28 cm², and a dealloying depth of ˜300 nm were illustrated. Nanoporous NiPt has a half-wave of ˜0.96 V, whereas the IL impregnated catalyst has a half-wave of ˜1.0 V, a significant improvement.

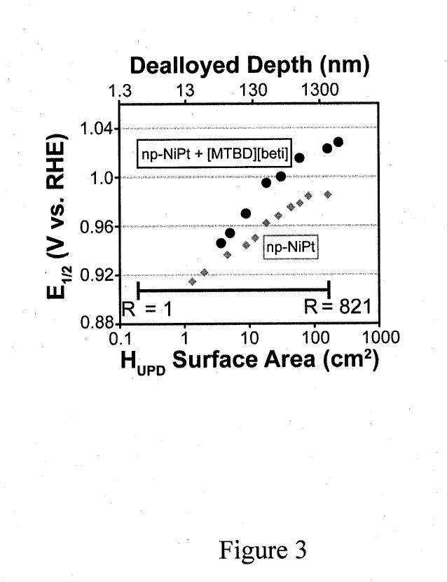

The position of the half-wave in a nanoporous catalyst depends on the depth of dealloying (or, alternatively, the “roughness factor” R=(surface area measured by hydrogen adsorption; “H_{UPD}”)/(geometric surface area). FIG. 3 shows the half-wave of the np-NiPt material compared to the np-NiPt+[MTBD][beti] composite catalyst at various dealloyed depths/roughness factors. It can be seen that the composite catalyst increases the effectiveness of the nanoporous metal.

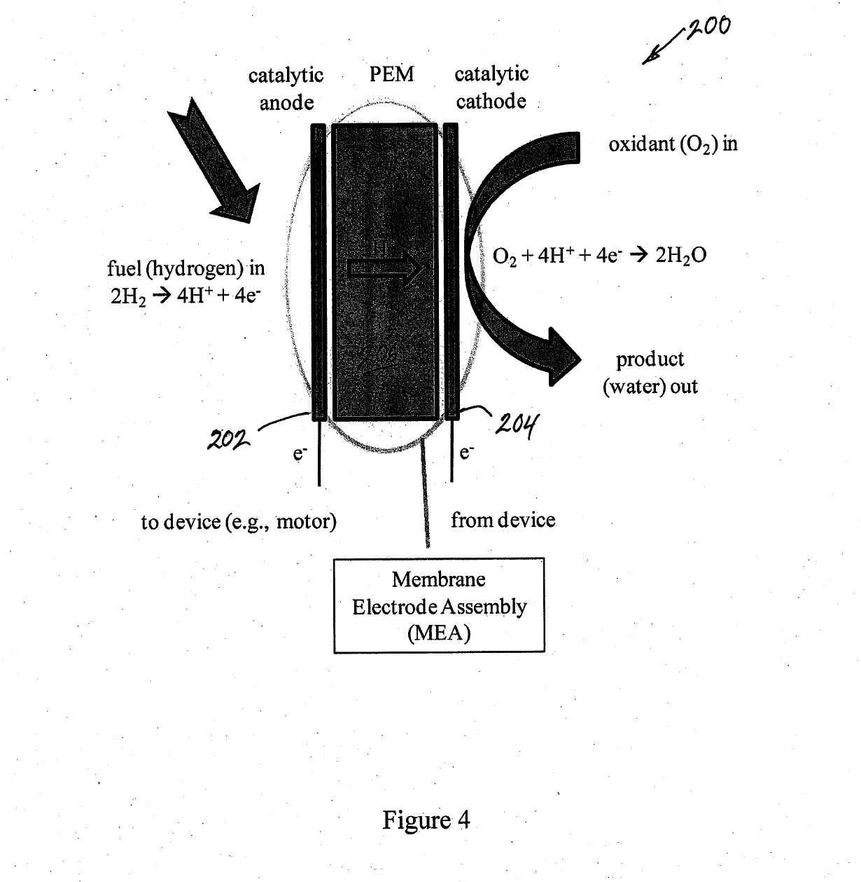

FIG. 4 is a schematic illustration of a fuel cell 200 according to an embodiment of the current invention. The fuel cell 200 has a first electrode 202, a second electrode 204 spaced apart from the first electrode 202, and an electrolyte 206 arranged between the first electrode 202 and the second electrode 204. At least one of the first electrode 202 and the second electrode 204 is coated with a composite catalyst according to embodiments of the current invention that are adapted for oxygen reduction. In some embodiments, the composite catalysts can be, but are not limited to, particulate, film or foil structural forms. The electrolyte 206 can be a solid electrolyte, for example, selected from currently available solid electrolytes used in fuel cells. However, other electrolytes may be selected according to the particular application. The first electrode 202, the second electrode 204 and the electrolyte 206 can provide a membrane electrode assembly (MEA) portion of the fuel cell 200. The fuel cell can include a plurality of MEAs as well as additional structures such as fuel input and exhaust structures that are only represented schematically in FIG. 4.

### EXAMPLES

The improvement of catalysts for the 4-electron oxygen reduction reaction (ORR; O₂+4H⁺+4e⁻→2H₂O) remains a critical challenge for fuel cells and other electrochemical energy technologies. Recent attention in this area has centered on the development of metal alloys with nanostructured compositional gradients (e.g., core/shell structure) that exhibit higher activity than supported Pt nanoparticles (Pt/C). For some examples, see the following:
Greeley, J., Stephens, I., Bondarenko, A., Johansson, T., Hansen, H., Jaramillo, T., Rossmeisl, J., Chorkendorff, I., Nørskov, J. Alloys of platinum and early transition metals as oxygen reduction electrocatalysts. Nature Chemistry 1, 552-556 (2009).
Paulus, U., Wokaun, A., Scherer, G., Schmidt, T., Stamenkovic, V., Markovic, N., Ross, P. Oxygen reduction on high surface area Pt-based alloy catalysts in comparison to well defined smooth bulk alloy electrodes. Electrochim. Acta 47, 3787-3798 (2002).
Stamenkovic, V., Mun, B., Mayrhofer, K., Ross, P., Markovic, N. Effect of Surface Composition on Electronic Structure, Stability, and Electrocatalytic Properties of Pt-Transition Metal Alloys: Pt-Skin versus Pt-Skeleton Surfaces. J. Amer. Chem. Soc. 128, 8813-8819 (2006).
Stamenkovic, V., Mun, B., Arenz, M., Mayrhofer, K., Lucas, C., Wang, G., Ross, P., Markovic, N. Trends in electrocatalysis on extended and nanoscale Pt-bimetallic alloy surfaces. Nature Mater. 6, 241-247 (2007).
Paffet, M., Beery, J., Gottesfeld, S. Oxygen Reduction at Pt_{0.65}Cr_{0.35}, Pt_{0.2}Cr_{0.8} and Roughened Platinum. J. Electrochem. Soc. 135, 1431-1436 (1988).
Zhang, J., Mo, Y., Vukmirovic, M., Klie, R., Sasaki, K., Adzic, R. Platinum Monolayer Electrocatalysts for O₂ Reduction: Pt Monolayer on Pd(111) and on Carbon-Supported Pd Nanoparticles. J. Phys. Chem. B 108, 10955-10964 (2004).
Zhang, J., Vukmirovic, M., Sasaki, K., Nilekar, A., Mavrikakis, M., Adzic, R. Mixed-Metal Monolayer Electrocatalysts for Enhanced Oxygen Reduction Kinetics. J. Am. Chem. Soc. 127, 12480-12481(2005).
Nilekar, A., Xu, Y., Zhang, J., Vukmirovic, M., Sasaki, K., Adzic, R., Mavrikakis, M. Bimetallic and Ternary Alloys for Improved Oxygen Reduction Catalysis. Top. Catal. 46, 276-284 (2007).

For instance, with a Pt outer surface and Ni-rich second atomic layer, Pt₃Ni(111) is one of the most active surfaces for the ORR (Stamenkovic, V., Fowler, B., Mun, B., Wang, G., Ross, P., Lucas, C., Markovic N Improved Oxygen Reduction Activity on Pt₃Ni(111) via Increased Surface Site Availability. Science 315, 493-497 (2007)) due to a shift in the d-band center of the surface Pt atoms that results in a weakened interaction between Pt and intermediate oxide species, freeing more active sites for O₂ adsorption (Paulus, U., Wokaun, A., Scherer, G., Schmidt, T., Stamenkovic, V., Markovic, N., Ross, P. Oxygen reduction on high surface area Pt-based alloy catalysts in comparison to well defined smooth bulk alloy electrodes. Electrochim. Acta 47, 3787-3798 (2002); Stamenkovic, V., Mun, B., Mayrhofer, K., Ross, P., Markovic, N., Rossmeisl, J., Greeley, J., Norskov, J. Changing the Activity of Electrocatalysts for Oxygen Reduction by Tuning the Surface Electronic Structure. Agnew. Chem. Int. Ed. 45, 2897-2901 (2006)). But enhancements due solely to alloy structure and composition may not be sufficient to improve the mass activity to a degree that satisfies the requirements for fuel cell commercialization (Gasteiger, H., Kocha, S., Sompalli, B., Wagner, F. Activity benchmarks and requirements for Pt, Pt-alloy, and non-Pt oxygen reduction catalysts for PEMFCs. Appl. Cat. B: Env. 56, 9-35 (2005)), especially as the high activity of particular crystal surface facets may not easily translate to polyfacetted particles. Here we show that a tailored geometric and chemical materials architecture can further improve ORR catalysis by demonstrating that a composite nanoporous Ni/Pt alloy (np-NiPt) impregnated with a hydrophobic, high-oxygen solubility, and protic ionic liquid (IL) has extremely high mass activity, functionally magnifying the intrinsic activity of the metal by chemically and structurally biasing O₂ to remain near the active region of the catalyst and expelling product water.

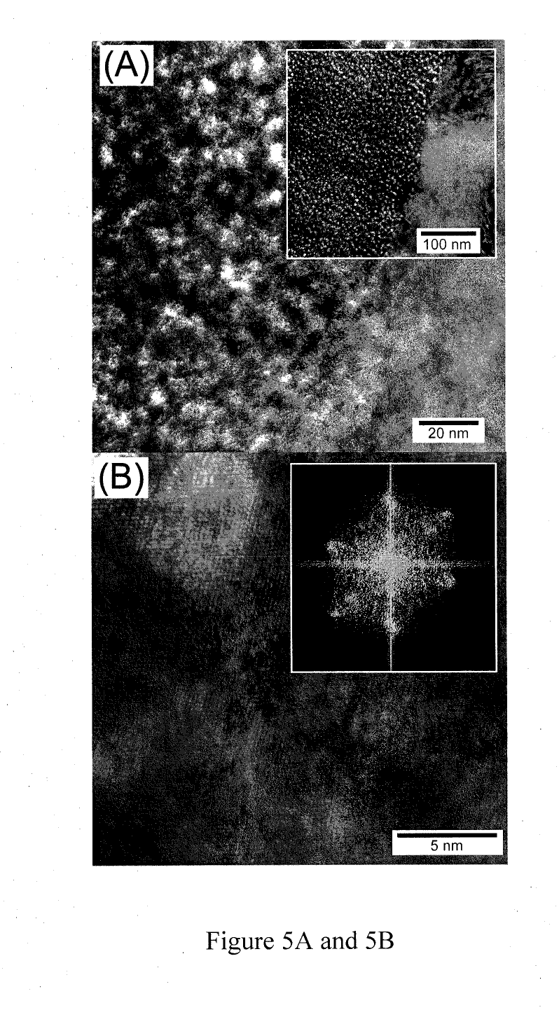

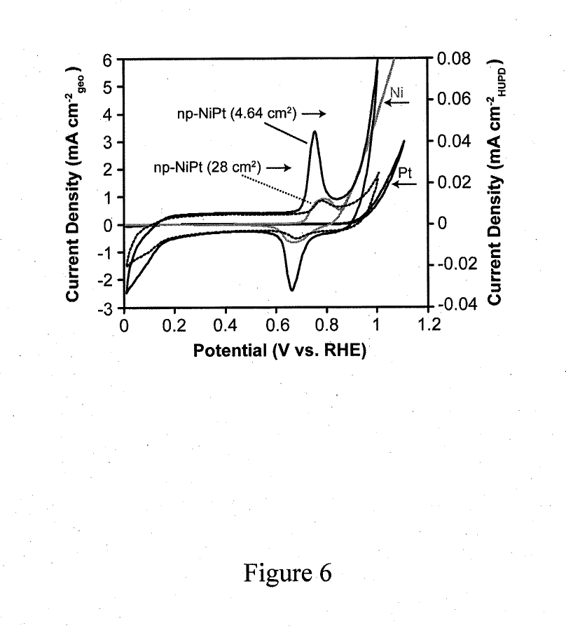

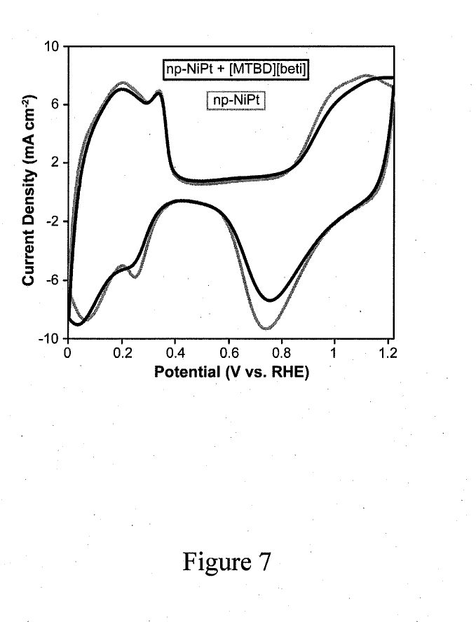

FIG. 5A is a cross-section transmission electron micrograph (TEM) showing the sharp etch front between a dense 77/23 at. % Ni/Pt precursor alloy (right side of image), and np-NiPt (left side of image) formed through the selective electrochemical dissolution (dealloying) of Ni from the precursor upon application of 2.1 V vs. RHE in 0.05 M NiSO₄. Typical of other dealloyable systems, the remaining Pt atoms have diffused along the alloy/electrolyte interface at the etch front to form a three-dimensional open porous metal whose pore/ligament size is orders of magnitude smaller than the grain size (Erlebacher, J., Aziz, M., Karma, A., Dimitrov, N., Sieradzki, K. Evolution of nanoporosity in dealloying. Nature 410, 450-453 (2001)). The resulting structure has a pore size of ˜2 nm, and the extended single crystal nature of the porosity is demonstrated by a high resolution TEM (HRTEM) micrograph, FIG. 5B, which shows uniform lattice fringes; the Fourier transform of this image shows obvious crystallographic symmetry. For shallow dealloying depths (<10 nm), electrochemical assays show some residual surface Ni in the porous layer, but deeper dealloying removes this Ni and generates a Ni-poor porous layer surface (FIG. 6). However, bulk composition analysis (EDS) shows the average residual composition of the porous region to be 30/70 Ni/Pt at. %. Together, these results suggest np-NiPt has a core/shell structure and thus falls into the category of “Pt-skin” catalysts like Pt₃Ni(111) (Stamenkovic, V., Fowler, B., Mun, B., Wang, G., Ross, P., Lucas, C., Markovic N. Improved Oxygen Reduction Activity on Pt₃Ni(111) via Increased Surface Site Availability. Science 315, 493-497 (2007); Stamenkovic, V., Schmidt, T., Ross, P., Markovic, N. Surface segregation effects in electrocatalysis: kinetics of oxygen reduction reaction on polycrystalline Pt₃Ni alloy surfaces. J. Electroanal. Chem. 554-555, 191-199 (2003)). FIG. 7 shows a cyclic voltammogram (CV) of np-NiPt in deoxygenated 0.1M H₂SO₄, and resembles the characteristic CV curves for typical high surface area Pt electrodes. Integration of the current in the electrochemical hydrogen underpotential deposition (H_{UPD}) region yields a surface area of 44 m² g⁻¹, comparable to Pt/C (Mani, P., Srivastava, R., Strasser, P. Dealloyed Pt—Cu Core-Shell Nanoparticle Electrocatalysts for Use in PEM Fuel Cell Cathodes. J. Phys. Chem. C 112, 2770-2778 (2008)) and consistent with other typical nanoporous metals (Liu, Y., Bliznakov, S., Dimitrov, N. Comprehensive Study of the Application of a Pb Underpotential Deposition-Assisted Method for Surface Area Measurement of Metallic Nanoporous Materials. J. Phys. Chem. C 113, 12362-12372 (2009)). H_{UPD} was also used to measured the roughness factor R=(H_{UPD} surface area)/(geometric surface area).

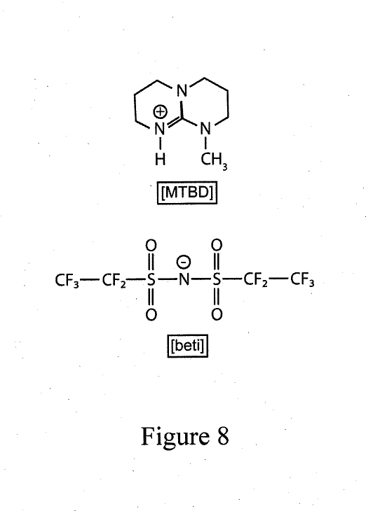

The composite materials design principle employed here was to impregnate the pores with a secondary phase with higher oxygen solubility than the exterior aqueous phase. In this structure, regardless of the potential, O₂ diffusing into the pores would be chemically biased to remain there, even if neither phase were fully saturated. Confined within a pore diameter (˜2 nm) of a catalytic surface, the frequency of interaction with the surface would be greatly increased. If the IL were also hydrophobic, then the product water would be expelled, and the overall effect would be a kind of structural Le Chatelier's principle. The criteria for a suitable secondary phase material according to an embodiment of the current invention are strict; it must be hydrophobic and capillary forces must keep it within the pores; it must be protic so that protons may be shuttled to the catalytic surface to participate in the ORR; it must be thermally stable; and most importantly, it must have a high O₂ solubility. Few materials exhibit all these characteristics, but a class of superbase derived ILs that do have been developed by H. Luo et al. (Luo, H., Baker, G., Lee, J., Pagni, R. Dai, S. Ultrastable Superbase-Derived Protic Ionic Liquids. J. Phys. Chem. B 113, 4181-4183 (2009)), of which it was found that [MTBD][beti] has a good combination of physical and chemical properties. The structure of [MTBD] [beti] IL is shown in FIG. 8 and it is made through a simple one-pot synthesis by neutralizing a Brœnsted base (7-methyl-1,5,7-triazabicyclo[4.4.0]dec-5-ene) with the lithium salt of a Brønsted acid (bis(perfluoroethylsulfonyl)imide). The free electrons on the nitrogen allow this IL to conduct protons, which are required for the reduction of O₂, and the perfluoroinated side chains of the [beti]⁻ anion make this IL hydrophobic and also give it an affinity for O₂, a trait common to many perfluorinated molecules (Gomes, M., Deschamps, J., Menz, D. Solubility of dioxygen in seven fluorinated liquids. J. Fluorine Chem. 125, 1325-1329 (2004)). The O₂ solubility and diffusivity in [MTBD][beti] was measured using a Pt microdisk electrode; values of D_{O}_{₂}_{,[MTBD][beti]}=7.19+0.52×10⁻⁶ cm²s⁻¹ and C_{O}_{₂}_{,[MTBD][beti]}=2.90±0.07 mM were found, an approximate threefold increase in O₂ solubility compared to aqueous HClO₄ (C_{O}_{₂}_{,HClO}_{₄}=1.21+0.05 mM). The nanoporous metal/ionic liquid composite catalyst is completed by impregnating the np-NiPt with [MTBD][beti] by simply placing a drop of the IL on a dry np-NiPt disk and allowing capillary forces to pull it into the pores.

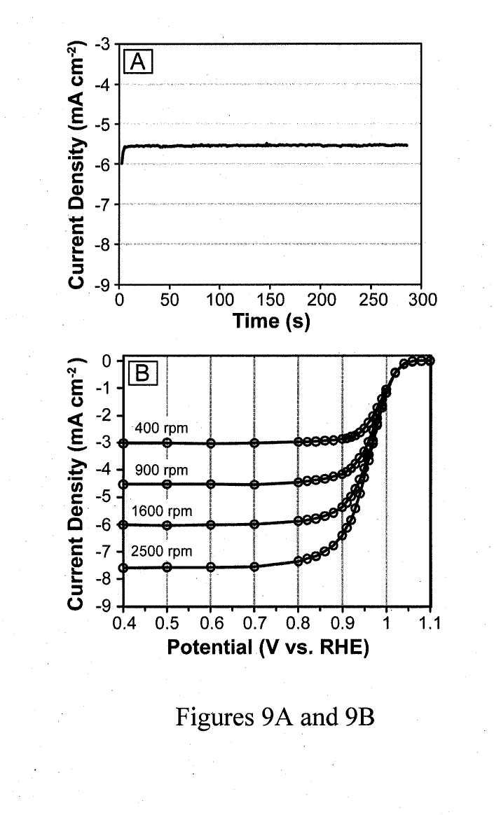

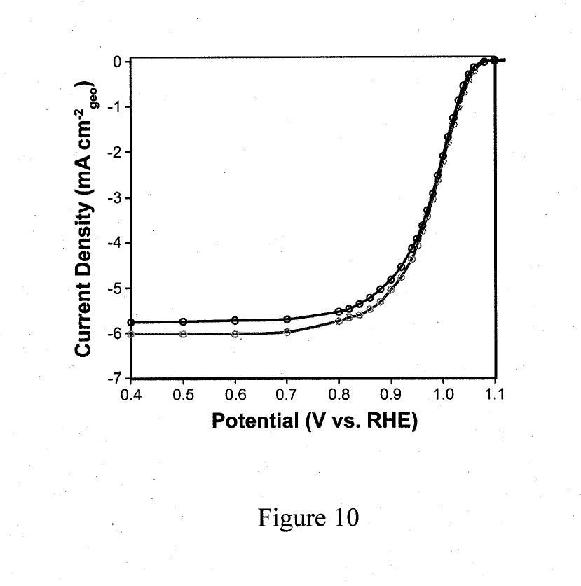

With the excess IL spun off and the disk immersed in oxygen-saturated 0.1M HClO₄, ORR currents at fixed potential are stable over hundreds of seconds (FIG. 9A), which allows a potentiostatic measurement of the catalyst activity versus potential (FIG. 9B). As shown in FIG. 10, the effect of the IL is to reduce the overpotential for the ORR by tens of mV. For this particular dealloyed depth (R=143), the half-wave potential for the bare np-NiPt electrode alone is quite high at 0.96 V vs. RHE, but integrated with [MTBD][beti], the half-wave potential shifts positive by 40 mV to 1.0 V vs. RHE, and still maintains the same diffusion limited current density. The half-wave potential versus dealloyed depth (and, equivalently, roughness factor and H_{UPD} surface area) is shown in FIG. 3. We find no evidence of catalyst degradation during measurement of the ORR activity through either active surface area loss through coarsening of the nanoporous structure, chemical reduction of the IL or segregation of the IL out of the pores. FIG. 10 contains the results of a stability test in which a composite electrode was rotated at 1600 rpm in oxygen saturated 0.1M HClO₄ at 25° C. while cycling the potential between 0.6 and 0.96 V vs. RHE for 3000 cycles. After cycling, there is only a small loss in activity, indicating that the composite catalyst is robust and stable. We also find a negligible liquid-liquid junction potential (see below).

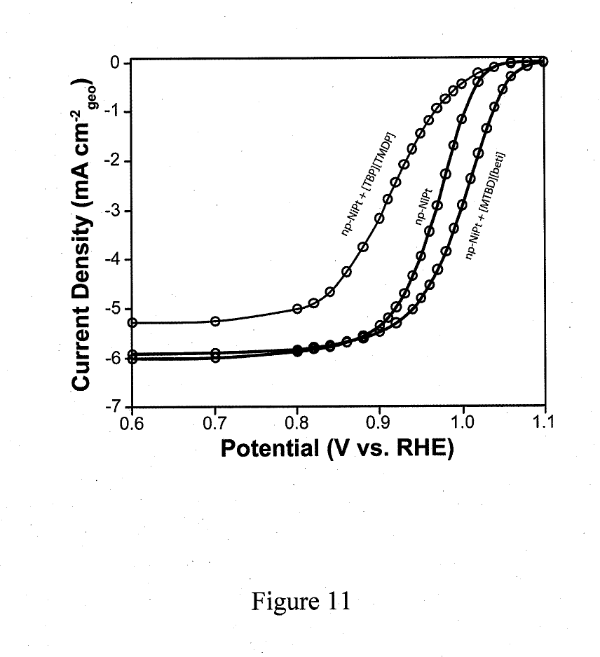

The roughness factors are the same in both sets of samples, with and without IL, therefore, the shift in potential must be due to chemical effects. Of the ILs assayed for this example, the most obvious correlation is with O₂ solubility. Further demonstration of the effect of O₂ solubility is shown in FIG. 11, which includes the ORR curve for a composite electrode impregnated with another hydrophobic, protic IL, [TBP][TMDP], for which we measure C_{O}_{₂}_{,[TBP][TMDP]}=0.889±0.101 mM. This solubility is lower than that of the external acid, resulting in an increase in the ORR overpotential; note also the decrease in the diffusion limited current density, which is directly proportional to the O₂ solubility in the lowest-solubility phase.

To find the intrinsic activity of the porous composite electrode, RDE theory was critically applied. Any measured RDE current has contributions from two main sources: an intrinsic kinetic current of O₂ reduction on the surface of the catalyst, and diffusional currents of O₂ through space above the surface of the electrodes. This current i is governed by the Koutecky-Levich (K-L) equation,

$$\frac{1}{i} = \frac{1}{{A}_{active} {j}_{k}} + \frac{1}{{A}_{geo} {j}_{D}} + \frac{1}{{i}_{P}} , \qquad ( 1 )$$

where jₖ and j_{D} are the kinetic and diffusion limited current densities respectively and iₚ is an extra resistance term associated with diffusion of reactants through a porous electrode given by i_{P}=(nFCₚDₚ)δ⁻¹. (Paulus, U., Wokaun, A., Scherer, G., Schmidt, T., Stamenkovic, V., Radmilovic, V., Markovic, N., Ross, P. Oxygen Reduction on Carbon-Supported Pt—Ni and Pt—Co Alloy Catalysts. J. Phys. Chem. B 106, 4181-4191(2002).) Here, n is the number of electrons, F is Faraday's constant, Cₚ and Dₚ are the reactant solubility and diffusivity in the pores, and δ is the porous layer thickness or diffusion distance. With the solubility and diffusivity values for [MTBD][bet] IL, and values for δ as large as the entire dealloyed layer thickness, 1/iₚ remains negligible compared to the other terms in the K-L equation. In principle, Equation (1) can be directly applied to find jₖ versus potential (the Tafel plot), but in practice there is an implicit assumption that the electroactive surface area for the reaction is linearly dependent on the loading (catalyst layer mass), i.e., that there is complete utilization of that surface during the reaction and A_{active}=H_{UPD} surface area. This assumption may not hold for nanoporous electrodes in which the reduction reaction may occur near the outermost geometric surface, especially at high overpotential. To avoid this complication, the intrinsic kinetic current was found through a series of measurements on electrodes with varying dealloyed depths, and the product A_{active}jₖ was extrapolated to a value corresponding to R=1. Details of this extrapolation are discussed below.

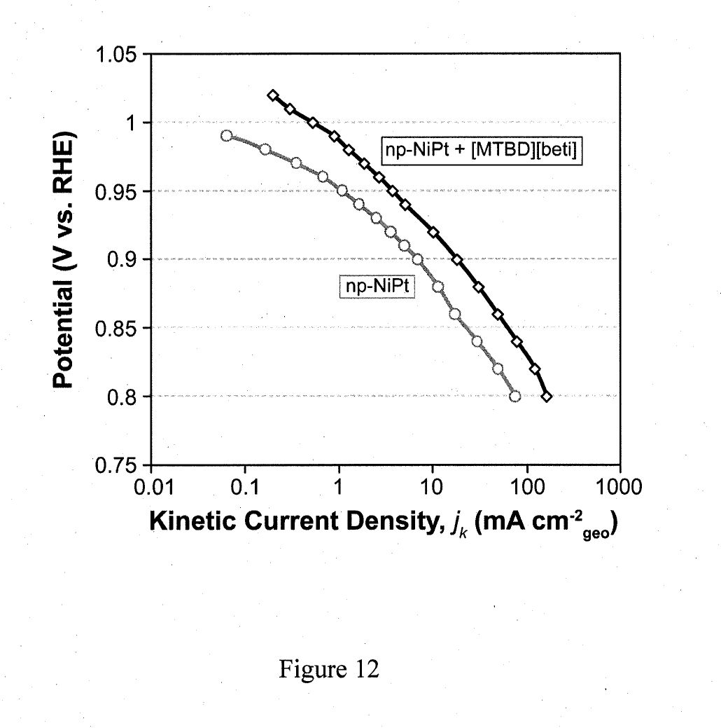

The Tafel plots for both np-NiPt and np-NiPt+[MTBD][beti] electrodes showing their intrinsic surface activities are shown in FIG. 12. Characteristic of Pt-based catalysts, both electrodes have slopes near −120 mV dec⁻¹ at high overpotential and −60 mV dec⁻¹ at low overpotential. At potentials below 0.95 V vs. RHE, the slope of the curves at fixed potential are approximately equal; suggesting that over the majority of the potential range probed, the reaction mechanism is the same, only the attempt frequency has increased. There is a slight difference in slope between the two materials at low overpotential (and also a subtle shift in the onset potential for Pt oxidation in the nonaqueous IL, FIG. 7) that may be associated with a different reaction mechanism in this potential region, such as adsorptive blocking of Pt surface oxide, an idea suggested by Yeager, but the deviation is small. (Clouser, S. J., Huang, J. C., Yeager, E. Temperature dependence of the Tafel slope for oxygen reduction on platinum in concentrated phosphoric acid. J. Appl. Electrochem. 23, 597-605 (1993); Ghoneim, M. M., Clouser, S., Yeager, E. Oxygen Reduction Kinetics in Deuterated Phosphoric Acid. J. Electrochem. Soc. 132, 1160-1162 (1985); Yeager, E., Razaq, M., Gervasio, D., Razaq, A., Tryk, D. Proc. of Workshop on Structural Effects in Electrocatalysis and Oxygen Electrochemistry, The Electrochemical Society 92-11, 440 (1993).) The simplest explanation for the overall increased activity of the composite electrode is biased O₂ confinement in the IL. Since early work on the ORR by Damjanovic, et al., it has been well known that ORR kinetic currents are proportional to the oxygen activity [a_{O}_{₂}] at the catalyst surface. See, for example:
Damjanovic, A., Brusic, V. Electrode kinetics of oxygen reduction on oxide-free platinum electrodes. Electrochim. Acta 12, 615-628 (1967);
Damjanovic, A., Genshaw, M. A. Dependence of the kinetics of O₂ dissolution at Pt on the conditions for adsorption of reaction intermediates. Electrochim. Acta 15, 1281-1283 (1970);
Markovic, N. M., Gasteiger, H. A., Grgur, B. N., Ross, P. N. Oxygen reduction reaction on Pt(111): effects of bromide. J. Electroanal. Chem. 467, 157-163 (1999); and
Sepa, B., Vojnovic, M., Damjanovic, A. Reaction Intermediates as a Controlling Factor in the Kinetics and Mechanism of Oxygen Reduction at Platinum Electrodes. Electrochim. Acta 26, 781-793 (1981).

Assuming the O₂ activity is approximately equal to the concentration at all potentials, the ratio of kinetic current density with and without IL should equal the ratio of solubilities. Indeed, we find the average ratio j_{k,np-NiPt+[MTBD][beti]}/J_{k,np-NiPT}=2.74±0.377 to be the same, within error, as C_{O}_{₂}_{, [mTBD][beti]}/C_{O}_{₂}_{,HClO}_{₄}=2.40±0.013.

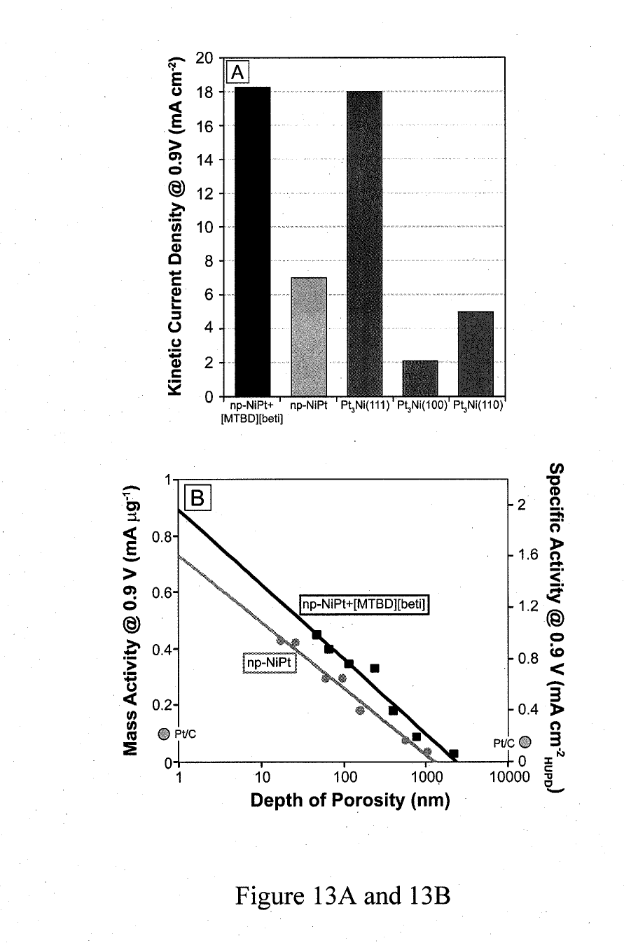

The intrinsic kinetic current density jₖ at 0.9 V vs. RHE is a standard metric for the comparison of activities of different ORR catalysts. FIG. 13A compares jₖ of np-NiPt and np-NiPt+[MTBD][beti] catalysts to the activity of low index faces of the Pt-skin catalyst Pt₃Ni (Stamenkovic, V., Fowler, B., Mun, B., Wang, G., Ross, P., Lucas, C., Markovic N Improved Oxygen Reduction Activity on Pt₃Ni(111) via Increased Surface Site Availability. Science 315, 493-497 (2007)). np-NiPt itself has a relatively high jₖ, 7 mA cm⁻² at 0.9 V, and this value sits between the jₖ values of the various crystallographic faces of Pt₃Ni. This is consistent with the proposed Pt-skin, core/shell structure of the polyfacetted porous crystal catalyst and also agrees with recent measurements on facetted Pt₃Ni nanoparticles (Zhang, J., Yang, H., Fang, J., Zou, S. Synthesis and Oxygen Reduction Activity of Shape-Controlled Pt3Ni Nanopolyhedra. Nano Lett. 10, 638-644 (2010)). When impregnated with IL, jₖ rises to 18.2 mA cm⁻² at 0.9 V vs. RHE, equal to the best single crystal surface catalysts. Another standard metric is mass activity, in which the kinetic current at a certain potential, again typically 0.9 V vs. RHE, is normalized by the total catalyst mass. FIG. 13B shows the mass activity at 0.9 V vs. RHE for both the np-NiPt and np-NiPt+[MTBD][beti] electrodes as a function of dealloyed depth. The data presented in this figure is not extrapolated to R=1; rather, each point is a raw kinetic current A_{active}jₖ divided by the catalyst layer mass. The secondary axis on the right side of the Figure also shows values for the raw kinetic current density at 0.9 V vs. RHE where the kinetic current is again not extrapolated but instead normalized by the H_{UPD} surface area for each particular electrode. Typical literature activities for supported nanoparticle Pt catalysts are shown for reference as points near both axes and are exceeded by the activities of both np-NiPt and np-NiPt+[MTBD][beti] at nearly all dealloyed depths, even considering that the mass activity for both electrodes decreases with increasing dealloyed depth. (Paulus, U., Wokaun, A., Scherer, G., Schmidt, T., Stamenkovic, V., Markovic, N., Ross, P. Oxygen reduction on high surface area Pt-based alloy catalysts in comparison to well defined smooth bulk alloy electrodes. Electrochim. Acta 47, 3787-3798 (2002); Gasteiger, H., Kocha, S., Sompalli, B., Wagner, F. Activity benchmarks and requirements for Pt, Pt-alloy, and non-Pt oxygen reduction catalysts for PEMFCs. Appl. Cat. B: Env. 56, 9-35 (2005); Markovic, N., Schmidt, T., Stamenkovic, V., Ross, P. Oxygen Reduction Reaction on Pt and Pt Bimetallic Surfaces: A Selective Review. Fuel Cells 1, 105-116 (2001); Srivastava, R. Mani, P., Hahn, N. Strasser, P. Efficient Oxygen Reduction Fuel Cell Electrocatalysis on Voltammetrically Dealloyed Pt—Cu—Co Nanoparticles. Angew. Chem. Int. Ed. 46, 8988-8991(2007); Lim, B., Jiang, M. Camarog, P., Cho, E., Tao, J., Lu, Z., Zhu, Y. Zia, Y. Pd—Pt Bimetallic Nanodendrites with High Activity for Oxygen Reduction. Science 324, 1302-1305 (2009).)

It is a reasonable hypothesis that a porous dealloyed composite particle will have a mass activity near that of the planar electrode with a dealloyed depth equal to that diameter. The data here suggests that a composite dealloyed nanoparticle geometry with ˜10 nm diameter would be an optimal catalyst architecture, possibly yielding mass activities nearly an order of magnitude higher than that of commercial Pt/C (Mayrhofer, K., Strmcnik, D., Blizanac, B., Stamenkovic, V., Arenz, M., Markovic, N. Measurement of oxygen reduction activities via the rotating disc electrode method: From Pt model surfaces to carbon-supported high surface area catalysts. Electrochim. Acta 53, 3181-3188 (2008)), and this could be increased further with the discovery of materials with which to fill the pore space that have even higher oxygen solubility. Significant factors here include the synthesis of porous mesoscopic particles and better secondary phase materials, but it is easy to envision how such an unsupported catalyst could be integrated into a H₂/O₂ PEM fuel cell cathode where high activity should translate into higher power output, and the composite architecture should assist with the corrosion and structural stability issues associated with supported nanoparticle catalysts.

In this example, we have developed a composite electrocatalyst comprised of nanoporous Ni/Pt impregnated with a hydrophobic, protic ionic liquid with high O₂ solubility that demonstrates very high activity for the ORR compared to any other catalyst for this reaction. Our results suggest this enhancement is a result of both the intrinsic high activity of the nanoporous electrode and the engineered chemical environment within the pores which biases the reaction toward completion. It is easy to see how an analogous composite could be formed in a system based on nanoparticle catalysts, and the results here point to new materials synthesis strategies for high surface area catalysts that leverage the surface reactivity of the component materials with the geometric environment in which these components are assembled.

### Materials and Methods

NiPt alloys were made by co-melting Ni (99.5%, Alfa Aesar) and Pt (99.997%, Alfa Aesar) in the desired ratio in a radio frequency induction (RF) furnace (Ameritherm EasyHeat) followed by a twelve hour anneal in vacuum at 950° C. (Barnstead-Thermolyne 1500). After homogenization, the alloys were milled into a disk with a diameter of 5 mm and geometric surface area of 0.196 cm² and polished down to a mirror finish using progressively finer diamond paste down to 0.1 micron (Buehler). After polishing, the disks were again annealed in vacuum at 950° C. to remove stresses associated with machining and polishing. Annealed disks were placed in the rotating disk electrode apparatus (Pine Instruments, AFMSCRE) and dealloyed in 0.05 M NiSO₄ (Alfa Aesar, hexahydrate, 99.97%) with an applied potential of 2.1V vs. RHE using a Gamry potentiostat. During dealloying at this potential oxygen was evolved and the electrode was rotated at 1600 rpm to assist in its removal. The reference electrode and counter electrode were Hg/Hg₂SO₄ (MSE) (Radiometer Analytical) and Pt mesh respectively for all electrochemical experiments unless stated otherwise. The reference electrode was calibrated against a hydrogen electrode fabricated according to the specifications in (Gong, S., Lu, J., Yan, H. Developing the self-contained hydrogen reference electrode. J. Electroanal. Chem. 436, 291-293 (1997)). Nitrogen was bubbled through a 0.1M HClO₄ (70%, Sigma Aldrich, redistilled 99.999%) solution for at least 30 min in order to remove any trace dissolved oxygen. Both the hydrogen electrode and Hg/Hg₂SO₄ electrode were placed in the solution and the voltage between them was measured to be 0.722 V. The Hg/Hg₂SO₄ offset from the hydrogen reference potential was further confirmed by multiple comparisons to other reference electrodes, as well as to the positions of characteristic peaks for H_{UPD} and Pt oxidation/reduction (Stamenkovic, V., Schmidt, T., Ross, P., Markovic, N. Surface segregation effects in electrocatalysis: kinetics of oxygen reduction reaction on polycrystalline Pt₃Ni alloy surfaces. J. Electroanal. Chem. 554-555, 191-199 (2003); Lim, B., Jiang, M. Camarog, P., Cho, E., Tao, J., Lu, Z., Zhu, Y. Zia, Y. Pd—Pt Bimetallic Nanodendrites with High Activity for Oxygen Reduction. Science 324, 1302-1305 (2009)) (all potentials here are reported versus the reversible hydrogen electrode, RHE). After dealloying the desired amount, the electrode was washed thoroughly by rotating in Millipore water (MilliQ Synthesis A10) with a resistivity greater than 18.2 MΩcm. Millipore water was also used for all electrolyte solutions. As a consequence of dealloying in a neutral pH solution, there is considerable residual oxide on the surface of the electrode. This oxide is reduced by cycling in 25° C. deoxygenated 0.1M H₂SO₄ (concentrated, ACS plus reagent, Fisher Scientific) from a potential of 0 V to 1.2 V vs. RHE at 50 mVs⁻¹. H_{UPD} surface areas of the samples were calculated from these curves by integrating the current in the H_{UPD} desorption wave (˜0 V to ˜0.4 V vs. RHE), subtracting out double layer capacitance and assuming 210 μC cm⁻². For ORR measurements, the electrode was again thoroughly rinsed in Millipore water and transferred to oxygen saturated 0.1M HClO₄ (70%, Sigma Aldrich, redistilled 99.999%); proton concentration was checked using a calibrated pH meter (Corning Scholar 415). ORR curves were obtained potentiostatically by fixing the potential until a steady current value was obtained, typically 10 to 60 seconds (O₂ was continuously bubbled through the solution to maintain O₂ saturation), thus limiting the effect that non-Faradaic currents ubiquitous in porous metals associated with non-zero sweep rate can have on current measurements. Four different rotation rates were used 400, 900, 1600 and 2500 rpm. All glassware was cleaned by soaking in a solution of concentrated H₂SO₄ and Nochromix cleaner (Godax Laboratories, Inc.) for at least eight hours followed by thorough rinsing in Millipore water. H_{UPD} measurements before and after oxygen reduction confirmed there was no significant further dealloying during the ORR measurement.

Thin TEM (transmission electron micrograph) foils with a cross-sectional view of the partially dealloyed samples were prepared using a Hitachi FB-2100 focused ion beam (FIB) system. The damaged surface layers of the TEM foils, caused by high-energy Ga ions, were removed by gentle ion milling at liquid nitrogen temperature. TEM and HRTEM (high resolution transmission electron microscopy) observations were performed by employing a JEM-3010 Field Emission Gun (FEG) TEM and Phillips CM-300FEG. Both microscopes were operated at 300 kV and had a point-to-point resolution better than 0.17 nm.

The [MTBD][beti] IL was made in sufficient quantities according to the procedure outlined in (Luo, H., Baker, G., Lee, J., Pagni, R. Dai, S. Ultrastable Superbase-Derived Protic Ionic Liquids. J. Phys. Chem. B 113, 4181-4183 (2009)). Briefly, equimolar amounts of the precursors 7-methyl-1,5,7-triazabicyclo[4.4.0]dec-5-ene [MTBD] (Sigma Adlrich) and the lithium salt of bis(perfluoroethylsulfonyl)imide [beti] (3M) dissolved in water along with 10.6 M HNO₃ (VWR, ACS, 70%) were cooled in ice to near 0° C. HNO₃ was added drop wise to the [MTBD] until a near neutral pH was reached. After neutralization, the [beti] solution was mixed with the [MTBD] and the IL precipitated out as a viscous fluid phase beneath the water phase. The IL was washed several times with DI water and then placed in a vacuum oven at 70° C. for twelve hours to remove residual water. O₂ solubility and diffusivity were measured using a Pt microelectrode made by sealing a 25 μm diameter Pt wire (Alfa Aesar, 99.95%) in a quartz capillary. After cleaning the Pt microelectrode by evolving H₂ in deoxygenated 0.1 M HClO₄, the microelectrode was placed in a sealed flow cell (contained within a faraday cage) in which O₂ was actively passed over the electrode. A drop of IL was placed on the microelectrode and a Ag wire (Alfa Aesar, 1 mm, 99.9%) cleaned in conc. HNO₃ followed by H₂ flame annealing was used as both a reference and counter electrode. After saturation with O₂, the potential was held at a point where there is no passage of Faradaic current followed by a step to a potential at which O₂ reduction on the microelectrode is diffusion limited. The resulting current curves were then fit using a model and procedure described in (Evans, R., Klymenko, O., Saddoughi, S., Hardacre, C., Compton, R. Electroreduction of Oxygen in a Series of Room Temperature Ionic Liquids Composed of Group 15-Centered Cations and Anions. J. Phys. Chem. B 108, 7878-7886 (2004); Huang, X., Rogers, E., Hardacre, C., Compton, R. The Reduction of Oxygen in Various Room Temperature Ionic Liquids in the Temperature Range 293-318K: Exploring the Applicability of the Stokes-Einstein Relationship in Room Temperature Ionic Liquids. J. Phys. Chem. B 113, 8953-8959 (2009)) from which we backed out the solubility and diffusivity data. The [TBP][TMDP] IL was made by neutralizing tetra-n-butylphosphonium hydroxide [TBP] (Sigma Aldrich, 40 wt. % in water) with 4,4′-trimethylene-dipyridine [TMDP] (Sigma Aldrich, 98%) in methanol (Fisher Scientific, HPLC grade) followed by removal of methanol in a reduced pressure atmosphere and its O₂ solubility and diffusivity were determined through the procedure previously described.

The liquid-liquid junction potential between [MTBD][beti] IL and aqueous electrolytes was measured by placing equal volumes of both the IL and DI water on either side of a quartz U-tube, the hydrophobicity of the IL prevented them from mixing. Sufficient amounts of AgNO₃ (Alfa Aesar, 99.995%) were added to each liquid to make 2 mM solutions. Ag wires etched in conc. HNO₃ and then flame annealed in a H₂ flame were placed in either solution and connected to a volt meter. The entire setup was placed into a sealed box and a flow of Ar was run through the box. The solutions were allowed to deoxygenate over night and after 12 hours the liquid-liquid junction potential was found to be 1.1 mV, which is negligible.

The composite electrodes were made by placing a drop of the [MTBD][beti] IL on the surface of a dry np-NiPt disk where capillary forces were allowed to pull the IL into the porous structure. The excess IL was spun off in the RDE and further cleaning of the electrode was accomplished through cycling in deoxygenated 0.1M HClO₄.

Dealloying of Ni/Pt Alloys to Make np-NiPt

Porosity evolution during dealloying refers to the selective electrochemical dissolution of an alloy component under conditions where the remaining component diffuses along the alloy/electrolyte interface to re-form into a highly porous metal (Erlebacher, J., Seshardi, R. Hard Materials with Tunable Porosity. MRS Bulletin 34, 561-566 (2009)). From a thermodynamic standpoint, the Pt/Ni system is a good dealloying candidate because the components form a uniform solid solution with the face-centered cubic crystal structure across their entire composition range, and because Pt is much more noble than Ni; both of these characteristics together can lead to nanoporosity evolution during dissolution due to a kinetic instability that competes dissolution of the less-noble alloy component with surface diffusion of the remaining component (Erlebacher, J., Aziz, M., Karma, A., Dimitrov, N., Sieradzki, K. Evolution of nanoporosity in dealloying. Nature 410, 450-453 (2001)). In practice, however, the Ni/Pt system exhibits some complications. First, thermal processing of the base material often results either in segregation of Pt to the surface to form a passivating Pt skin (Pourbaix, M. Atlas of Electrochemical Equilibria in Aqueous Solutions (Pergamon Press, Oxford, New York, 1966); Stamenkovic, V., Fowler, B., Mun, B., Wang, G., Ross, P., Lucas, C., Markovic N. Improved Oxygen Reduction Activity on Pt₃Ni(111) via Increased Surface Site Availability. Science 315, 493-497 (2007)), or in Ni-rich alloys, the formation of a passivating Ni oxide. These problems were overcome by dealloying in neutral electrolyte at high potentials, greater than 2.1 V (all potentials here are reported versus the reversible hydrogen electrode, RHE). At these potentials, we suspect there is enough electrochemical driving force to break through any passivation layer; once broken-through, exposed Ni is susceptible to dissolution. Chemical dissolution is assisted by acidification of the electrolyte in the vicinity of the etch front by hydrolysis of the surface Ni to a Ni hydroxide (Ni(OH)₂); Ni(OH)₂ is soluble in the acidified pores, but precipitates out of solution when it diffuses into the bulk of the neutral electrolyte. Dealloying in the Ni/Pt system can also be done in acidic solutions, but the neutral solutions used here are benign. More importantly, in neutral solutions, acidification of the electrolyte which generates the reduced species that participate in surface diffusion and porosity evolution is confined to the moving dissolution front (Snyder, J., Livi, K., Erlebacher, J. Dealloying Silver/Gold Alloys in Neutral Silver Nitrate Solution: Porosity Evolution, Surface Composition, and Surface Oxides. J. Electrochem. Soc. 155, C464-C473 (2008)); behind the dissolution front, the material forms a surface oxide that morphologically stabilizes the nanoscale porosity. Dealloying was found to occur in alloys with Pt contents as low as 1% Pt, but good structurally stable porosity evolution only occurred for compositions of Pt between 15-25%, of which the optimal ORR activity was centered at 23 at. % Pt.

### Kinetic Analysis of ORR Data on Nanoporous Electrodes

Use of the K-L equation to kinetically analyze ORR data requires adoption of particular assumptions, specifically: the electroactive surface area is linearly dependent on the loading and that there is complete utilization of that surface during the reaction. In other words, A_{active} is made equal to the electroactive surface area found through H_{UPD}. For our nanoporous composite catalyst we can change the loading by dealloying to varying depths and we find that the electroactive surface area increases linearly with dealloyed depth. But we find a particular peculiarity when comparing electrodes with low and high loadings. If we use the K-L equation with A_{active} equal to the H_{UPD} surface area to determine the kinetic current density at 0.9 V vs. RHE, the electrode with a low loading or shallow dealloyed depth has a jₖ of 10 mA cm⁻² whereas the electrode with a higher loading or deeper dealloyed depth has a jₖ of 0.1 mA cm⁻², this is not an intuitive result. If the surface composition is the same, the pore size and surface structure are the same, then the normalized kinetic current density should be the same for all loadings. What this suggests is that porous electrodes may behave differently than planar or nanoparticulate electrodes in that A_{active} may not always be equal to the H_{UPD} surface area.

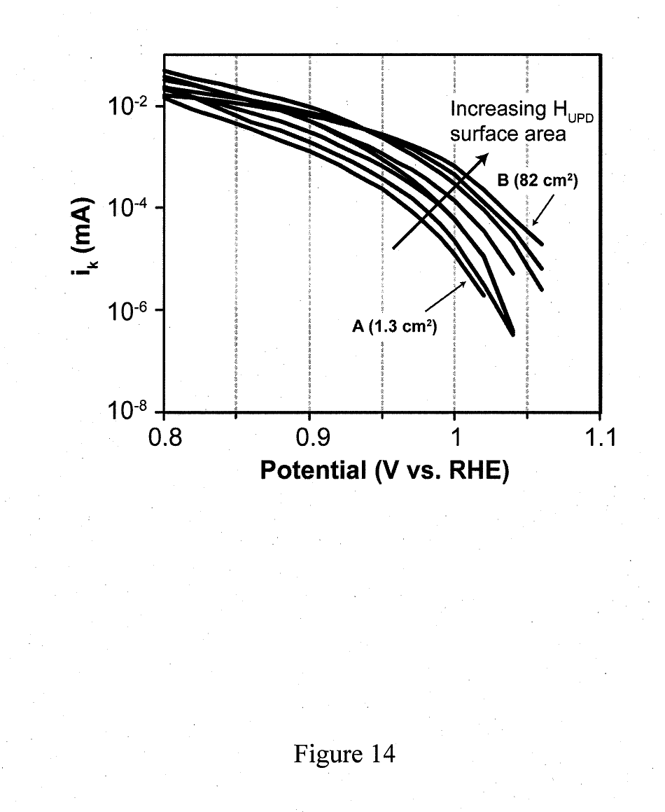

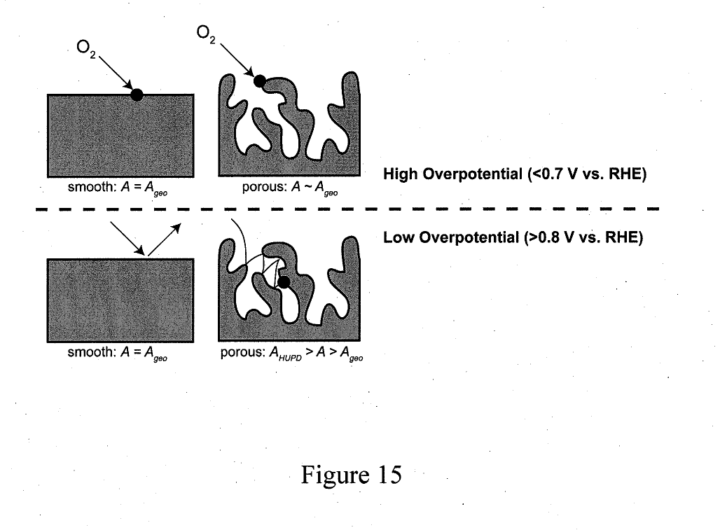

If we plot the kinetic current (iₖ) as a function of potential for electrodes with varied loadings or dealloyed depths, FIG. 14, there appear to be two distinct regions, one at low overpotential where the currents diverge with higher currents for higher loadings and one at high overpotential where the currents converge. This provides evidence that for porous electrodes not only may A_{active} not always be equal to the H_{UPD} surface area but that A_{active} itself may be a function of potential. Consider a thought experiment with two different types of catalytic surfaces, a smooth or planar surface and a porous surface, FIG. 15. At high overpotential the reaction probability is approaching unity, therefore when an O₂ molecule diffuses to the electrode from the electrolyte it reduces when it comes in contact with the outer surface, and so for both the smooth and porous surface the active surface area is effectively equal to the geometric surface area of the electrode. In contrast, at low overpotential, the probability of an O₂ molecule reacting when it contacts the surface is much lower therefore it is more likely to rebound off of the surface without reacting. The case is slightly different for the porous electrode because there is the possibility of the O₂ molecule becoming trapped within the porous structure, contacting the surface multiple times until it is finally reduced. At lower overpotential, O₂ molecules are allowed to sample more of the surface of the porous electrode resulting in a higher electroactive surface area. This geometric effect may be the origin of the divergence in the iₖ curves at lower overpotential where the electrodes with higher loading or deeper dealloyed depths have higher iₖ values in that potential range.

This variability in A_{active} with applied potential complicates the data analysis and indicates that depth of porosity must be accounted for by an analysis that deconvolutes the effects of porosity from the intrinsic kinetic activity of the nanoporous composite catalyst. We believe that the most straightforward method for determination of the intrinsic kinetic current density jₖ of the nanoporous electrodes as a function of potential (Tafel plot) is to measure the kinetic current iₖ for electrodes with different roughness factors (dealloyed depths) and extrapolate the iₖ at each potential for all of the electrodes back to a roughness factor of R=1 and then normalize by the geometric surface area. The result of this extrapolation is shown as Tafel plots in FIG. 12.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. It is intended, therefore, that the invention be defined by the scope of the claims that follow and that such claims be interpreted as broadly as is reasonable.

We claim:

1. A composite catalyst for a chemical reaction, comprising:
a porous metal catalyst that catalyzes a plurality of reactants to provide a reaction product; and
a reaction-enhancing material disposed within pores defined by said porous metal catalyst,
wherein said reaction-enhancing material enhances attraction of at least one reactant of said plurality of reactants into said pores defined by said porous metal catalyst, and
wherein said reaction-enhancing material enhances expulsion of said reaction product from said pores defined by said porous metal catalyst.

2. A composite catalyst according to claim 1, wherein said reaction-enhancing material is a liquid in which said at least one reactant is more soluble than a local environment that exposes said composite catalyst to said at least one reactant.

3. A composite catalyst according to claim 1, wherein said reaction-enhancing material is a liquid in which said reaction product is less soluble than a local environment that receives said reaction product.

4. A composite catalyst according to claim 1, wherein said porous metal catalyst catalyzes an oxygen reduction reaction to provide H₂O as a reaction product, O₂ is more soluble in said reaction-enhancing material than H₂O, and said reaction-enhancing material is hydrophobic.

5. A composite catalyst according to claim 4, wherein said reaction-enhancing material is an ionic liquid.

6. A composite catalyst according to claim 5, wherein said ionic liquid is at least one of [MTBD][beti] or [MTBD][Tf₂N].

7. A composite catalyst according to claim 1, wherein said porous metal catalyst has a specific surface area that is greater than 5 m²/g and less than 100 m²/g.

8. A composite catalyst according to claim 1, wherein said porous metal catalyst has a specific surface area that is greater than 40 m²/g and less than 50 m²/g.

9. A composite catalyst according to claim 1, wherein said porous metal catalyst has a specific surface area that is about 44 m²/g.

10. A composite catalyst according to claim 1, wherein said porous metal catalyst comprises platinum (Pt).

11. A composite catalyst according to claim 10, wherein said porous metal catalyst is an alloy that further comprises nickel (Ni).

12. A composite catalyst according to claim 11, wherein said porous metal catalyst is an alloy consisting essentially of platinum and nickel.

13. A composite catalyst according to claim 12, wherein said porous metal catalyst is an alloy further satisfying the following formula
PtₓNi₁₋ₓ,
wherein x is at least 0.6 and as large as 1.

14. A composite catalyst according to claim 13, wherein x is 0.67.

15. A composite catalyst according to claim 1, wherein said porous metal catalyst comprises a metal selected from the group of metals consisting of titanium, iron, cobalt, nickel, copper, iridium, rhenium, aluminum, manganese, palladium, osmium, rhodium, vanadium, chromium and combinations thereof.

16. A composite catalyst according to claim 1, wherein said porous metal catalyst has an ensemble average pore diameter that is less than about 10 μm.

17. A composite catalyst according to claim 1, wherein said porous metal catalyst has an ensemble average pore diameter that is less than 100 nm.

18. A composite catalyst according to claim 1, wherein said porous metal catalyst has an ensemble average pore diameter that is greater than 1 nm and less than 50 nm.

19. A composite catalyst according to claim 1, wherein said porous metal catalyst has an ensemble average pore diameter that is greater than 1 nm and less than 4 nm.

20. A composite catalyst according to claim 1, wherein said porous metal catalyst has an ensemble average pore diameter that is greater than 2 nm and less than 3 nm and an average ligament diameter that is greater than 2 nm and less than 3 nm.

21. A fuel cell, comprising:
a first electrode;
a second electrode spaced apart from said first electrode; and
an electrolyte arranged between said first and said second electrodes,
wherein at least one of said first and second electrodes is at least one of coated with or comprises a composite catalyst,
wherein said composite catalyst comprises:
a porous metal catalyst that catalyzes a plurality of reactants to provide a reaction product; and
a reaction-enhancing material disposed within pores defined by said porous metal catalyst,
wherein said reaction-enhancing material enhances attraction of at least one reactant of said plurality of reactants into said pores defined by said porous metal catalyst, and
wherein said reaction-enhancing material enhances expulsion of said reaction product from said pores defined by said porous metal catalyst.

22. A fuel cell according to claim 21, wherein said reaction-enhancing material is a liquid in which said at least one reactant is more soluble than a local environment that exposes said composite catalyst to said at least one reactant.

23. A fuel cell according to claim 21, wherein said reaction-enhancing material is a liquid in which said reaction product is less soluble than a local environment that receives said reaction product.

24. A fuel cell according to claim 21, wherein said porous metal catalyst catalyzes an oxygen reduction reaction to provide H₂O as a reaction product, O₂ is more soluble in said reaction-enhancing material than H₂O, and said reaction-enhancing material is hydrophobic.

25. A fuel cell according to claim 24, wherein said reaction-enhancing material is an ionic liquid.

26. A fuel cell according to claim 25, wherein said ionic liquid is at least one of [MTBD][beti] or [MTBD][TF₂N].

27. A fuel cell according to claim 21, wherein said porous metal catalyst has a specific surface area that is greater than 5 m²/g and less than 100 m²/g.

28. A fuel cell according to claim 21, wherein said porous metal catalyst has a specific surface area that is greater than 40 m²/g and less than 50 m²/g.

29. A fuel cell according to claim 21, wherein said porous metal catalyst has a specific surface area that is about 44 m²/g.

30. A fuel cell according to claim 21, wherein said porous metal catalyst comprises platinum (Pt).

31. A fuel cell according to claim 30, wherein said porous metal catalyst is an alloy that further comprises nickel (Ni).

32. A fuel cell according to claim 31, wherein said porous metal catalyst is an alloy consisting essentially of platinum and nickel.

33. A fuel cell according to claim 32, wherein said porous metal catalyst is an alloy further satisfying the following formula
PtₓNi₁₋ₓ,
wherein x is at least 0.6 and as large as 1.

34. A fuel cell according to claim 33, wherein x is 0.67.

35. A fuel cell according to claim 21, wherein said porous metal catalyst comprises a metal selected from the group of metals consisting of titanium, iron, cobalt, nickel, copper, iridium, rhenium, aluminum, manganese, palladium, osmium, rhodium, vanadium, chromium and combinations thereof.

36. A fuel cell according to claim 21, wherein said porous metal catalyst has an ensemble average pore diameter that is less than about 10 μm.

37. A fuel cell according to claim 21, wherein said porous metal catalyst has an ensemble average pore diameter that is less than 100 nm.

38. A fuel cell according to claim 21, wherein said porous metal catalyst has an ensemble average pore diameter that is greater than 1 nm and less than 50 nm.

39. A fuel cell according to claim 21, wherein said porous metal catalyst has an ensemble average pore diameter that is greater than 1 nm and less than 4 nm.

40. A fuel cell according to claim 21, wherein said porous metal catalyst has an ensemble average pore diameter that is greater than 2 nm and less than 3 nm and an average ligament diameter that is greater than 2 nm and less than 3 nm.

41. A method of producing a composite catalyst, comprising:
providing a metal alloy;
de-alloying said metal alloy to provide a porous metal catalyst that catalyzes a plurality of reactants to provide a reaction product; and
adding a reaction-enhancing material to said porous metal catalyst such that said reaction-enhancing material is disposed within pores defined by said porous metal catalyst,
wherein said reaction-enhancing material enhances attraction of at least one reactant of said plurality of reactants into said pores defined by said porous metal catalyst, and
wherein said reaction-enhancing material enhances expulsion of said reaction product from said pores defined by said porous metal catalyst.

42. A method of producing a composite catalyst according to claim 41, wherein said adding said reaction-enhancing material adds a liquid reaction-enhancing material that is drawn into and held within said pores defined by said porous metal catalyst by capillary forces.
